(19) United States
(12) Patent Application Publication
(10) Pub. No.: US 2012/0055869 A1
(43) Pub. Date: Mar. 8, 2012

(54) WATER TREATMENT REACTOR SCREENING SYSTEM AND METHOD

(75) Inventors: Jack Collie Gardiner, Houston, TX (US); Gerald Seidl, Houston, TX (US); Stephen A. Smith, Houston, TX (US)

(73) Assignee: Headworks Bio Inc., Houston, TX (US)

(21) Appl. No.: 13/202,307

(22) PCT Filed: Feb. 17, 2010
(86) PCT No.: PCT/US10/24431

§ 371 Date: Oct. 31, 2011

Related U.S. Application Data
(60) Provisional application No. 61/154,277, filed on Feb. 20, 2009.

(51) Int. Cl. C02F 3/04; B01D 35/28

(52) U.S. Cl. 210/615; 210/151

(57) ABSTRACT

A screen configuration is provided for the extraction of wastewater from a wastewater reactor, while precluding the entry of biological support media. The screen may be formed as a tubular structure, and may be drum-like or have wings in a T-shaped configuration. A flow modifier within the screen may include one or more tubes extending into the screen and forming annular sections around the tubes. Flow through the screen, then, is directed around the inner flow modifier tubes and through the tubes. The resulting pressures and flow velocities are such that slot velocities through openings in the screen are generally constant along the length of the screen, and the flow is more efficiently distributed. The screen may be reduced in length as compared to conventional wastewater treatment screens.

### CROSS-REFERENCE TO RELATED APPLICATIONS

This application is a Nonprovisional Patent Application of U.S. Provisional Patent Application No. 61/154,277, entitled “Water Treatment Reactor Screening System and Method”, filed Feb. 20, 2009, which is herein incorporated by reference in its entirety.

### BACKGROUND OF THE INVENTION

The present invention relates generally to the field of wastewater treatment systems, and more particularly to screens used in wastewater treatment reactors.

A wide range of wastewater treatment systems are known and are currently in use. Many such systems are large installations permanently positioned near wastewater treatment sites, such as municipalities, industries, and so forth. In general, such wastewater treatment may be divided into several stages, including primary treatment, secondary treatment, and tertiary treatment. Primary treatment often involves simple filtering, screening and removal of grit, sludge and debris. Secondary treatment may involve a range of chemical and biological processes. For example, a common process known as biochemical oxygen demand reduction (BOD) aims to reduce contaminants in wastewater by the action of bacterial or other microbial agents. Other secondary processes may include nitrification, and de-nitrification, among others. Tertiary treatment often involves “polishing” or final filtration intended to produce effluent that meets certain local or design standards. In certain applications, primary treatment alone may be employed, or secondary treatment alone may be used, or primary and secondary treatment may be used without tertiary treatment, all depending upon the desired effluent qualities.

In certain processes used in wastewater treatment, biological support media are employed that serve to form a point of attachment for bacteria and other microbial agents used for the intended process. For example, in BOD reactors, nitrification reactors and de-nitrification reactors, various physical configurations of media may be employed that can be circulated in the wastewater and that support the biological growth. Currently available media include various plastics molded, extruded, cut or otherwise formed into shapes that provide large surface areas for the biological growth while still permitting the flow of wastewater over all surfaces to promote the exchanges necessary for the intended treatment.

A concern in such systems is the proper circulation of water and biological growth support media, as well as its retention in the specific reactor. For example, aeration systems are often employed that continuously or periodically bubble air through the wastewater to provide the necessary gas constituents to the biological growth, and to circulate both the wastewater and the support media. A typical reactor may have a substantial portion of its volume filled with such media, which freely circulates within the wastewater. As water is drawn from the reactor to enter downstream processes, such as processes within the same secondary treatment, or for tertiary treatment, the water must be efficiently extracted, while preventing the biological support media from being drawn into a subsequent process, reactor or piping.

The transfer of wastewater from one secondary treatment reactor to another is typically performed via gravity feed, although pumps may also be employed. To ensure that the media is not drawn from a reactor, various screen configurations are employed. For example, tubular screens may extend from a wall of the reactor and wastewater may enter each screen along its length. The screens may be positioned at a level just below the surface of the wastewater such that there is a constant flow of water through all sides of the screens.

However, very little has been done in the field to optimize the configuration or even the length of such screens. Because the cost of the screens is a function of their length and size, it is generally unknown in the field whether properly sized screens or even the optimal number of screens is being employed. Moreover, for screens that extend considerable distances from the side of a reactor vessel, support structures must be provided to hold the screens in place for extended periods of use.

There is a need, therefore, for improved techniques for wastewater treatment that offer more efficient and cost-effective screening in reactor vessels to prevent the escape of biological support media.

### BRIEF DESCRIPTION OF THE INVENTION

The present invention provides a novel screening technique designed to response to these needs. The technique makes use of tubular or drum-shaped screens, or screens that may be formed in various configurations, such as T-shapes. The screens include one or more flow modifiers that may comprise pipes or tubes that extend longitudinally into the screens. The flow modifiers effectively distribute the pressures and velocities tending to draw water into the screens more effectively along the length of the screens. In particular, the flow modifiers may aid in producing a velocity at slots within the screens that is relatively constant along the screen length. Consequently, the overall length of the screens may be reduced while still providing the same or better flow characteristics as longer screens without flow modifiers. The overall cost and effectiveness of the screening systems are therefore improved.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 is a diagrammatical representation of an exemplary portion of a wastewater treatment system employing improved screens in accordance with present techniques;

FIG. 2 is a diagrammatical plan view of a portion of a reactor of the type illustrated in FIG. 1 showing a series of drum screens extending from a sidewall thereof;

FIG. 3 is a similar diagrammatical plan view of a portion of a wastewater treatment reactor with a T-shaped screen;

FIG. 4 is a side view of an exemplary drum screen supported from the sidewall of a reactor vessel in accordance with aspects of the present techniques;

FIG. 5 is a similar view of a drum screen suspended from the sidewall of a reactor vessel;

FIG. 6 is a diagrammatical sectional view through an exemplary drum screen with two flow modifiers disposed in the screen to more evenly distribute flow into the screen along its length;

FIG. 7 is a similar view of a drum screen with a single flow modifier;

FIG. 8 is a diagrammatical sectional view of an exemplary T-shaped screen with a pair of flow modifiers for distributing flow along the length of each wing of the T;

FIG. 9 is a diagrammatical representation of a two screen portions with slots separating the screen material, and illustrating the flow of wastewater through these slots as affected by the flow modifiers within the screen; and

FIG. 10 is a graphical representation of slot velocity versus length for an exemplary screen having flow modifiers in accordance with the present techniques.

### DETAILED DESCRIPTION OF THE INVENTION

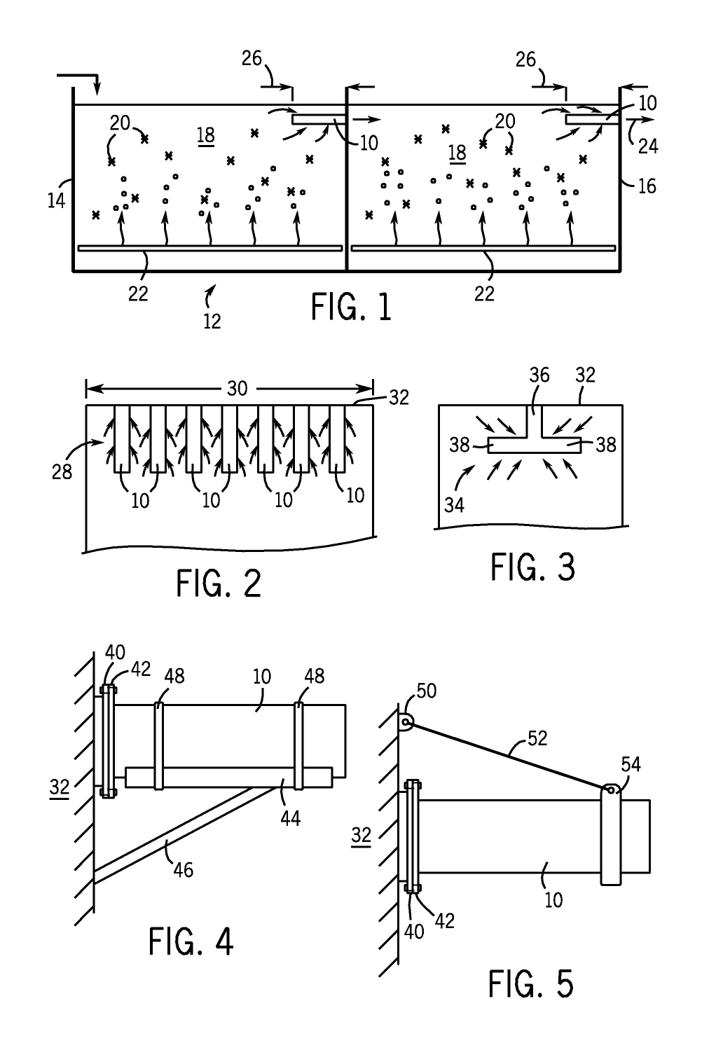

Turning now to the drawings, and referring first to FIG. 1, a pair of tubular screens 10 in accordance with the present techniques are shown in a wastewater treatment system 12. As will be appreciated by those skilled in the art, the wastewater treatment system 12 may be part of a larger treatment system in which wastewater is screened, debris, silt, grit, sludge, and so forth is removed along with contaminants, and the wastewater is finally filtered or polished for various purposes. The wastewater treatment system 12 shown in FIG. 1 includes a pair of reactors 14 and 16 that will be designed to receive wastewater 18. The reactors may perform the same or different wastewater treatment processes, and wastewater from reactor 14 is generally allowed to flow into reactor 16, from which the wastewater may proceed to further downstream processes. By way of example, the reactors may be designed to perform operations such as biochemical oxygen demand reduction, nitrification, de-nitrification, and so forth.

The reactions taking place in reactors 14 and 16 are aided by bacteria or other microbial growth supported on biological support media as indicated by reference numeral 20 in the figures. This support media may include various shapes of molded, cut, extruded, or otherwise formed plastics having substantial exposed surfaces on which the microbial growth is supported. Moreover, the biological support media includes openings over which wastewater can flow to support the biological growth and to promote the exchanges between the wastewater and the biological growth sufficient to carry on the intended reactions. An aeration system 22 may be supported within each reactor to bubble air into the wastewater, thereby providing nutrients for the biological growth, and circulating both the biological support media and the wastewater within each reactor. It should be noted that the screen configurations described herein may be equally well used in reactor vessels that do not use aeration systems, but that may use other types of mixing, including pulsed air, hydraulic, and mechanical mixing systems.

One or more tubular screens 10 are disposed within each reactor. The number, size and configuration of the screens may vary, depending upon such factors as the volume of the reactor, the volumetric or mass flow rate of wastewater intended, the residence time of the wastewater in each reactor, and so forth. The screens allow wastewater to flow from each reactor, while preventing the biological support media from exiting the respective reactor. As will be appreciated by those skilled in the art, the length of the screens, indicated by reference numeral 26, may also vary, as may the diameter and type of screen (e.g., the size and number of holes in the screens).

The screens illustrated in FIG. 1 include flow modifiers, as described in greater detail below, that allow for the intake of water into the screens to be more evenly distributed along the screens as compared to extended prior art screens with no such flow modifiers. For example, as will also be appreciated by those skilled in the art, as the length of the screens increases, if no other modification is done to the screens, velocities and flow rates will tend to be higher near the wall of the reactor vessel, with portions of the screen distal from the wall experiencing lower flow velocities and rates. The flow modifiers described below allow for shorter lengths 26 while maintaining highly effective flow along substantially the entire length of the screens. This may be accomplished by maintaining a substantially constant slot velocity along the length of the screens. As a result, velocities and pressures inside and outside of the screens are sufficient to more efficiently utilize the entire screen length, while avoiding unnecessarily high pressure drops or velocities that could cause the biological growth support media to be held against the screen surface.

FIG. 2 illustrates and exemplary reactor in which a series of drum screens extends from a sidewall. The collection of screens 28 may be generally similar to those illustrated in FIG. 1. However, owing to the width 30 of the sidewall 32, it is beneficial to distribute flow from the reactor through a number of screens disposed along the wall. FIG. 3 is a similar representation of a T-shaped screen in a reactor vessel. The T-shaped screen 34 has a base 36 from which water may flow from the reactor, as well as wing-like screen sections 38. Water may flow into the screen sections 38 and, therefrom, through the base 36 and out of the reactor. As with the drum screens as shown in FIG. 2, multiple such T-shaped screens may be provided in a reactor, depending upon the reactor design.

The screens may be supported in the reactors in various ways. For example, as shown in FIG. 4, a drum screen may extend form a reactor wall and be coupled to the reactor wall by a flanged arrangement. In the illustrated embodiment, an effluent port is provided in the reactor vessel wall, with a flange 40 spaced from the sidewall 32 of the reactor. A mating flange 42 is provide on the screen 10 that may be coupled to flange 40 and thus secured in place by appropriate bolts. A support 44, such as a metal profile (e.g., channel) cradles the screen and is, itself, supported by a strut 46. The support 44 may be configured in various ways to provide adequate mechanical support to the otherwise cantilevered screen, while typically minimizing the surface area of the screen that will experience restricted flow. The strut 46 may be secured to the sidewall of the reactor vessel, and may be bolted or welded to the support 44. The screen is held in place on the support by one or more bands 48.

FIG. 5 illustrates an alternative configuration in which a similar screen is suspended from the sidewall of the reactor vessel. In this arrangement, the screen 10 is similarly coupled to the port for effluent flow by flanges 40 and 42. However, a bracket 50 is, in this embodiment, attached to the sidewall 32 of the vessel, and a suspension member 52 secured between this bracket and a support band 54 on the screen. It should be noted that even in the configuration of FIG. 5, the screen may undergo gravitational and lifting loads, such that member 52 may be a rigid member capable of resisting such loading.

It should be appreciated, however, that the types of arrangements illustrated in FIGS. 4 and 5 for support of the screens are exemplary only. T-shaped screens may have similar support arrangements, but configured to adequately mechanically support the winged screened sections. In a presently contemplated embodiment, for example, an eyelet may be provided (e.g., by welding) that extends from the screen end plate. Support members may be bolted or otherwise attached to this eyelet for support. Moreover, in some embodiments, the length of the screens may be reduced to an extent that will allow for significantly lighter or less flow-affecting support structures as compared to prior art screening systems. It may be possible, moreover, to provide screens that can be cantilevered from the flange attachment without further support.

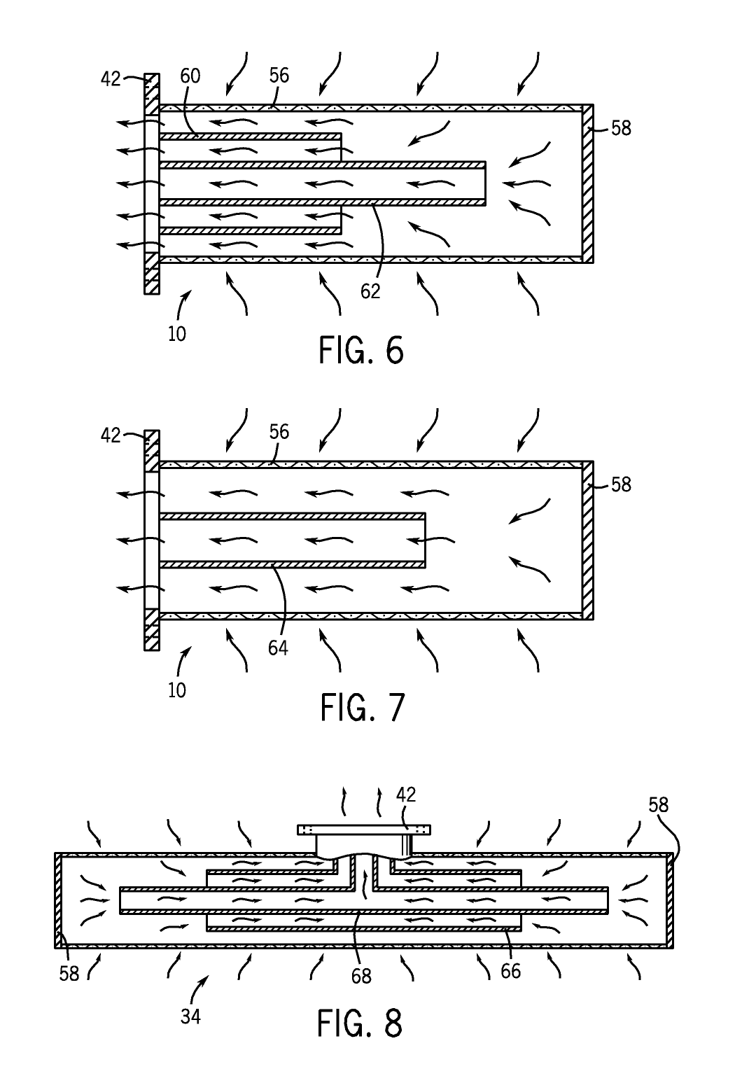

FIG. 6 illustrates an exemplary drum screen having flow modifiers in accordance with aspects of the present technique. The screen is formed as a tubular shell of screen-like mesh material resistant to corrosion, such as stainless steel. Openings in the screen permit the inflow of wastewater to an interior volume from which the wastewater may flow out to a downstream process, reactor, holding tank, or the like. The tubular screen includes a flange 42 by means of which it may be attached to a mating flange on the sidewall of a reactor as described above. The screen body 56 extends from the flange and has a closed end 58 which may be formed of a plate welded or otherwise attached to the screen body.

Wastewater may flow into the screen from all sides, and flows within the screen towards the flange 42 to exit through a central opening in the flange. Within the screen body, first and second flow modifier tubes 60 and 62 are coaxially positioned. The first flow modifier tube, which may be referred to as an outer tube, extends a first distance within the screen body, while a second, inner modifier tube 62 extends further into the screen body. The flow modifier tubes are secured to the flange or to support structures extending from the flange (not shown) to maintain their position within the screen body. Water entering the screen body may take one of three flow paths. That is, water entering nearest the flange with typically flow through an annular area surrounding the first or outer flow modifier tube 60. Water flowing into the screen beyond the end of the first or outer flow modifier tube 60 may also flow through this annular area, but at least a portion of the flow will be directed through an annular area between the outer flow modifier tube and the inner flow modifier tube. Still further, water entering a still more distal region of the screen may flow through either of the first annular areas or through the center of the second or inner flow modifier tube 62. In all cases, the water entering the structure will flow out through flange 42. As discussed in greater detail below, it has been found that the use of the flow modifier tubes tends to more evenly distribute inflow, flow rates, and pressures along the entire length of the screen body.

FIG. 7 illustrates a similar drum screen with a single flow modifier. The screen effectively operates in a similar manner, but with the single flow modifier 64 coaxially extending into the inner volume surrounded by the screen body 56. Water entering the screen body around the exterior of the modifier tube 64 will typically flow in an annular area around this tube, with water entering beyond the flow modifier tube end flowing either through the same annular area or through the flow modifier tube itself. Here again, all water exits through the opening in the flange.

FIG. 8 illustrates and exemplary T-shaped screen with similar flow modifiers. As noted above, the T-shaped screens include wings or screen sections that extend on either side of a central base. In this case, the base is coupled to the flange 42. Flow modifier tubes 66 and 68 are disposed in the screen body, and also form similar T-shapes. The outer flow modifier tube has a base section and two wing sections extending therefrom, while the inner tube, although similarly configured, is disposed inside the outer tube.

Flow in the T-shaped screen of FIG. 8 generally proceeds as follows. Water entering either side of the screen adjacent to the outer periphery of the outer tube 66 will typically flow around this outer tube and out through an annular area between the outer tube and an opening in the flange 42. Water entering beyond the ends of the outer tube may flow through this area or through annular areas between each side of the outer tube and the outer periphery of inner tube 68. Water entering closer to the ends of each side or wing of the structure may flow through the inner flow modifier tube, or through either of the annular areas previously mentioned.

It should be noted that the T-shaped screen configuration may be formed by a pair of drum screens, with flow modifiers in each. For example, drum screens if the type described above may be attached to a central flanged T-shaped structure. The flow paths, however, and effects of the flow modifiers on the slot velocities and overall flow rates would be essentially the same as those for the structure described above.

The particular size, lengths, wall thicknesses, materials and so forth of the flow modifier tubes may vary depending upon the particular application. For example, certain applications may require one, two or three such flow modifier tubes, depending upon such factors as the length of the screen, the configuration of the screen, the diameter of the screen, and the desired flow rate. The number and dimensions of the flow modifier tubes will also typically be a function of the sizes and number of openings in the screens. By way of example only, in a typical presently contemplated drum-type screen, two flow modifiers may be provided. The inner flow modifier tube extends into the screen body to a location at approximately ⅔ of its length, while the outer flow modifier extends to a location at approximately ⅓ of the length of the screen body.

As noted above, the use of flow modifiers in the screens allows for several advantages as compared to screens used in existing wastewater treatment systems. In particular, the flow modifiers tend to even the inlet flow along the length of the screens by altering the velocity of the water through the screen body. Accordingly, because more of the screen surface area serves to draw water from the surrounding reactor, the screens may be made significantly shorter as compared to those used in existing systems. By way of example, existing wastewater treatment systems may use drum screens without flow modifiers with lengths of approximately 4 m, with slot velocities on the order of 50 m/hr. Screens with flow modifiers of the type described above can replace these screens with equal effectiveness, but with a length of only 1 m, with slot velocities of between approximately 150 and 550 m/hr, and more particularly between approximately 200 and 275 m/hr. Similarly, for shorter conventional screens (e.g., 1 m), the same lengths may be used for screens with flow modifiers, but with reduced diameters. In both cases, a reduced number of screens may be used in a particular vessel, again with equal overall flow rates. The resulting structures are therefore more cost effective, owing to the shorter length of tubular screen material needed. Moreover, they require lighter support structures due to their reduced length.

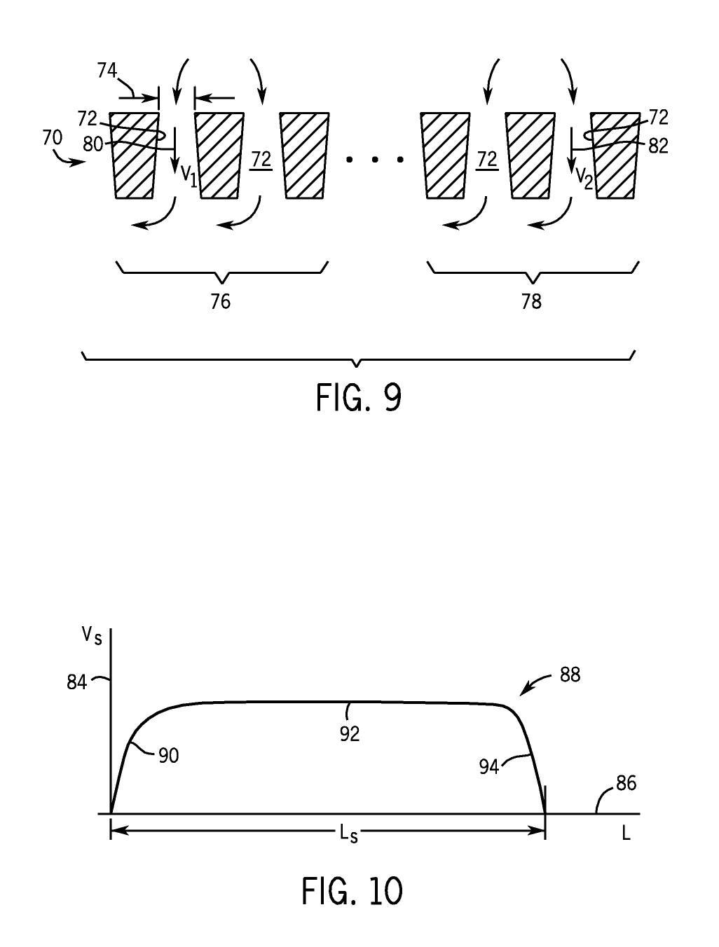

FIG. 9 illustrates the effect of the flow modifiers on the velocity of water entering the screen body. In particular, FIG. 9 shows a portion of the mesh 70 that forms the outer shell of the screen body. In the illustrated embodiment, the material forming the body has generally trapezoidal-shaped cross-sections surrounding openings or slots 72 therebetween. Water enters from the large side of the trapezoids, or from the slot perspective through the smaller side of the slot as indicated by width 74 labeled in FIG. 9. Once the water enters, the water travels through each slot and eventually joins the inner volume where the water flows around or through the flow modifier tubes as described above.

In the illustration of FIG. 9, a series of slots is illustrated on a flange side of the screen body, labeled with reference numeral 76, while a similar series is illustrated towards an end side, labeled with reference numeral 78. The slot velocity of the water entering through each slot is a function of the mass or volumetric flow rate through the slot and the slot dimensions. The provision of the flow modifiers in the screens distributes pressures and flow rates within the screens such that the slot velocities near the flange side of the screens is generally similar to the slot velocity near the end, and at points therebetween. The slot velocity for slots near the flange, represented in FIG. 9 by reference numeral 80, then, is similar to the slot velocity 82 for slots more distal from the flange. Moreover, slot velocities at the neck of each slot are generally similar along the length of the tubes.

FIG. 10 illustrates this ideal relationship graphically. In particular, the vertical axis 84 in FIG. 10 represents slot velocity, while the horizontal axis 86 represents the length along the tubular screen. Trace 88, then, represents the magnitude of slot velocity along the length of the screen Ls. It is the goal of the flow modifiers to produce a distribution of slot velocities essentially similar to trace 88. That is, while slot velocities near the flange will eventually be reduced significantly, as represented by portion 90 of the trace, slightly away from the flange and along most of the length of the screen, a generally constant slot velocity 92 will be produced. Further, near the end of the screen, the slot velocity will again be diminished up to the very end slot. Ultimately, a goal of the flow modifiers is to maximize the length and uniformity of the central portion 92 of the trace, and thereby to maximize the number of slots effective for transmission of wastewater through the screen, while evening out the flow distribution along the screen.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A wastewater treatment system comprising:
a reactor configured to receive wastewater and biological growth support media; and
a screen extending into the reactor and coupled to an exit port through which wastewater may exit the reactor, the screen allowing wastewater to flow through the exit port while preventing the biological growth support media from flowing into the screen, the screen having an outer screen body and at least one flow modifier tube disposed therein to distribute flow of wastewater into the screen along a length of the screen body.

2. The system of claim 1, wherein the screen includes a first flow modifier tube extending a first length into the screen body, and a second flow modifier tube disposed in the first flow modifier tube and extending into the screen body a second length greater than the first length.

3. The system of claim 2, wherein the first flow modifier extends to a location at approximately ⅓ of the length of the screen body, and the second flow modifier extends to a location at approximately ⅔ of the length of the screen body.

4. The system of claim 1, wherein the screen and flow modifier produce a slot velocity through slots of the screen of at least approximately 150 m/hr.

5. The system of claim 1, wherein the flow modifier tube produces slot velocities of wastewater through slots in the screen body that are generally equal along a length of the screen body.

6. The system of claim 1, wherein the reactor includes a plurality of similar screens extending into the reactor.

7. The system of claim 1, wherein the screen body is generally drum shaped.

8. The system of claim 1, wherein the screen body is generally T-shaped.

9. The system of claim 1, comprising a support structure coupled to a wall of the reactor and to the screen to mechanically support the screen during operation.

10. The system of claim 9, wherein the support structure is coupled to an end plate of the screen.

11. The system of claim 1, wherein the screen is cantilevered from a wall of the reactor with no further support.

12. A wastewater treatment system comprising:
a reactor configured to receive wastewater and biological growth support media; and
a plurality of screens extending into the reactor along a wall thereof and coupled to respective exit ports through which wastewater may exit the reactor, the screens allowing wastewater to flow through the exit ports while preventing the biological growth support media from flowing into the screens, each screen having an outer screen body and at least one flow modifier tube disposed therein to distribute flow of wastewater into the screen along a length of the screen body, a total effluent flow of wastewater from the reactor being directed collectively through the plurality of screens

13. The system of claim 12, wherein each screen includes a first flow modifier tube extending a first length into the screen body, and a second flow modifier tube disposed in the first flow modifier tube and extending into the screen body a second length greater than the first length.

14. The system of claim 13, wherein the first flow modifier extends to a location at approximately ⅓ of the length of the screen body, and the second flow modifier extends to a location at approximately ⅔ of the length of the screen body.

15. The system of claim 12, wherein the screen and flow modifier produce a slot velocity through slots of the screen of at least approximately 150 m/hr.

16. A wastewater treatment system comprising:
a reactor configured to receive wastewater and biological growth support media; and
a screen extending into the reactor and coupled to an exit port through which wastewater may exit the reactor, the screen allowing wastewater to flow through the exit port while preventing the biological growth support media from flowing into the screen, the screen comprising means for generally equalizing slot velocities of wastewater entering slots of the screen along the length thereof.

17. The system of claim 16, wherein the means for generally equalizing slot velocities of wastewater includes a flow modifier tube extending coaxially into a screen body.

18. The system of claim 16, wherein means for generally equalizing slot velocities of wastewater includes a first flow modifier tube extending coaxially a first length into the screen body, and a second flow modifier tube disposed coaxially in the first flow modifier tube and extending into the screen body a second length greater than the first length.

19. The system of claim 18, wherein the first flow modifier extends to a location at approximately ⅓ of the length of the screen body, and the second flow modifier extends to a location at approximately ⅔ of the length of the screen body.

20. The system of claim 18, wherein the screen and flow modifiers produce a slot velocity through slots of the screen of at least approximately 150 m/hr.

21. A wastewater treatment method comprising:
disposing a screen in a wastewater treatment reactor configured to receive wastewater and biological growth support media, the screen extending into the reactor and coupled to an exit port through which wastewater may exit the reactor, the screen allowing wastewater to flow through the exit port while preventing the biological growth support media from flowing into the screen, the screen comprising means for generally equalizing slot velocities of wastewater entering slots of the screen along the length thereof.

22. The method of claim 21, wherein the screen has a slot velocity through slots of the screen of at least approximately 150 m/hr.

23. The method of claim 21, comprising supporting the screen with a support structure that extends between the screen and a wall of the reactor.
